(19) United States
(12) Patent Application Publication
(10) Pub. No.: US 2014/0343706 A1
(43) Pub. Date: Nov. 20, 2014

(54) Customizable Healing Abutment

(71) Applicants: Timothy O. Hart, Glendale, WI (US); Michael Martinsen, Superior, WI (US)

(72) Inventors: Timothy O. Hart, Glendale, WI (US); Michael Martinsen, Superior, WI (US)

(21) Appl. No.: 14/277,499

(22) Filed: May 14, 2014

Related U.S. Application Data
(60) Provisional application No. 61/823,168, filed on May 14, 2013.

(51) Int. Cl. B29C 67/00; A61C 8/00

(52) U.S. Cl. CPC B29C 67/0088; A61C 8/008
USPC 700/97; 433/173

(57) ABSTRACT

A custom healing abutment and a method of manufacturing the same. The custom healing abutment can include a head with a customizable geometry configured to engage the surrounding gingival tissue to form an anatomically desirable emergence profile in the gingival tissue during healing. The method of manufacturing the custom healing abutment may include either additive or subtractive fabrication of the custom healing abutment directly or a casting pattern from which the custom healing abutment may be cast.

### CROSS-REFERENCE TO RELATED APPLICATION

The application claims the benefit of U.S. Ser. No. 61/823,168 filed May 14, 2013, the disclosure of which is incorporated herein in its entirety.

### FIELD OF THE INVENTION

The present invention is generally directed to a healing abutment for use with a dental implant and a method of manufacturing the same, and more particularly, to a customized healing abutment having a geometry that is personalized to an individual's anatomical requirements.

### BACKGROUND OF THE INVENTION

Dental implant surgery typically includes the surgical placement of an implant device into the jawbone of a patient as a means of providing a structural foundation for a dental prosthetic. The dental implant procedure includes an initial step of preparing the implant site by drilling a pilot hole configured to receive the dental implant into the jawbone using one or more bone drills, i.e., an osteotomy. After the hole has been prepared, the dental implant is screwed into the hole and surrounding bone. The implant is typically a headless titanium screw having a shaft and external threads. The shaft may be straight or tapered and the threads are configured to engage the bone to secure the implant. In some embodiments, the external surface of the dental implant may be specially contoured to promote osseointegration of the bone onto the dental implant.

Once the dental implant has been placed in the patient's bone, it is typically allowed a period of two to six months of healing time to ensure that the implant has been osseointegrated before a permanent dental prosthetic is affixed to the implant. During the healing process a healing abutment or cover screw is secured within a threaded channel that extends into the interior of the implant. The healing abutment extends from the upper surface of the dental implant, which is also approximately the upper surface of the jaw bone, and through the mucosa or soft gingival tissues. The healing abutment provides a structure around which the gingiva expands while healing from the dental implant surgery, and prevents the gingiva from expanding over the surface of the recessed dental implant.

After the healing stage is complete, the healing abutment is removed from the dental implant and a permanent abutment is secured within the channel that extends into the interior of the dental implant. The final abutment similarly extends from the dental implant, in which it is secured, through the gingival tissue. However, the permanent abutment differs in two significant ways: (1) the portion of the abutment that passes through the gingival tissue is often tapered or flared outwards toward the upper surface, and (2) it includes an approximately cylindrical extension above the upper surface of the gingiva onto which the restorative prosthetic, such as a crown, bridge or denture is secured.

When a healing abutment is used during the healing stage of the dental implant process, prior to the placement of a permanent abutment, it is possible for differences in the shape of the two abutments to result in undesirable gingival healing patterns. That is to say that generic or non-customized healing abutments are typically cylindrical in shape with vertical sidewalls and designed to cover the majority of, if not all of, the upper surface of the dental implant. This shape ensures that there will be no gingiva in-growth over the upper surface of the dental implant that may otherwise impede placement of the permanent abutment and associated dental prosthetic. However, this cylindrical shape of the healing abutment undesirably results in a corresponding emergence profile in the gingival tissue, namely cylindrical gingival growth with a circular emergence profile cross-section. When the permanent abutment, which is often anatomically contoured, is then placed into this circular emergence profile it is common for the permanent abutment to fit poorly in relation to the surrounding gingival tissue. In some locations the permanent abutment is larger than the cylindrical emergence profile, in which case the tissue needs to be compressed in order to properly fit the permanent abutment. This results in esthetically unpleasing blanching of the surrounding tissue as well as pain or discomfort for the patient. Alternatively, in some cases the permanent abutment is smaller than the cylindrical emergence profile, in which case a gap is present between the abutment and surrounding tissue, which is both esthetically unpleasing and capable of catching food, plaque, calculus or bacteria. Prior attempts to build an anatomically accurate healing abutment have been made, but have failed to provide for individual customizable healing abutments. Accordingly, there is a need for a custom healing abutment having a geometry that is personalized to an individual's anatomical requirements, and a method of manufacturing the same.

### SUMMARY OF THE INVENTION

Illustrative embodiments according to the invention are directed towards a custom healing abutment having a geometry that is personalized to an individual's anatomical requirements.

In one aspect, the invention includes a custom healing abutment having customizable geometry.

In another aspect, the invention includes a custom healing abutment configured to engage the surrounding gingival tissue to form an anatomically desirable emergence profile in the gingival tissue during healing.

In another aspect, the invention is directed towards a method of manufacturing a custom healing abutment having a geometry that is personalized to an individual's anatomical requirements.

In one aspect, the inventive method includes additive fabrication.

In another aspect, the inventive method includes subtractive fabrication.

In yet another aspect, the inventive method includes direct fabrication of the custom healing abutment.

In still another aspect, the inventive method includes fabrication of a casting pattern corresponding to the custom healing abutment, from which the abutment may be cast.

Numerous other aspects, features, and advantages of the present invention will be made apparent from the following detailed description together with the drawing figures.

### BRIEF DESCRIPTION OF THE DRAWINGS

The disclosed embodiments will be further explained with reference to the attached drawings, wherein like structures are referred to by like numerals throughout the several views. The drawings are not necessarily to scale, the emphasis having instead been generally placed upon illustrating the principles of the invention and the disclosed embodiments.

FIG. 1 is a front end view of a healing abutment as is known in the art;

FIG. 2 is an isometric view of dental implant with a permanent abutment and crown as is known in the art;

FIG. 3 is a front end view of a custom healing abutment having a geometry that is personalized to an individual's anatomical requirements in accordance with at least one embodiment of the present invention;

FIG., 4 is an partially transparent isometric view of dental implant including a custom healing abutment having a geometry that is personalized to an individual's anatomical requirements in accordance with an alternative embodiment of the present invention;

FIG. 5 is a longitudinal cross sectional view of dental implant including a custom healing abutment in accordance with the alternative embodiment of the present invention shown in FIG. 4;

FIG. 6 shows a flow chart of a method of manufacturing a custom healing abutment having a geometry that is personalized to an individual's anatomical requirements in accordance with at least one embodiment of the present invention, the method including the milling of the healing abutment;

FIG. 7 shows a flow chart of another method of manufacturing a custom healing abutment in accordance with at least one embodiment of the present invention, the method including the milling of a casting pattern for use in casting the healing abutment;

FIG. 8 shows a flow chart of another method of manufacturing a custom healing abutment in accordance with at least one embodiment of the present invention, the method including the printing of the healing abutment;

FIG. 9 shows a flow chart of another method of manufacturing a custom healing abutment in accordance with at least one embodiment of the present invention, the method including the printing of a casting pattern for use in casting the healing abutment;

FIG. 10 shows a flow chart of another method of manufacturing a custom healing abutment in accordance with at least one embodiment of the present invention, the method including an additive or subtractive fabrication method.

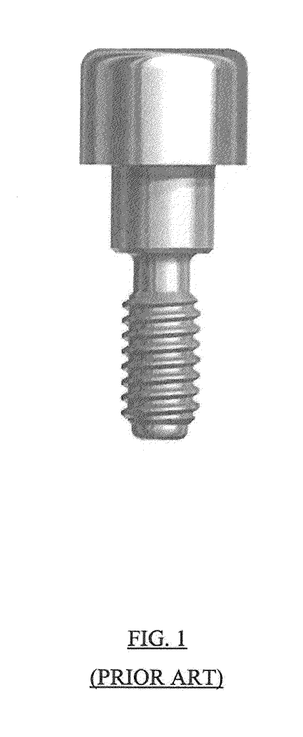

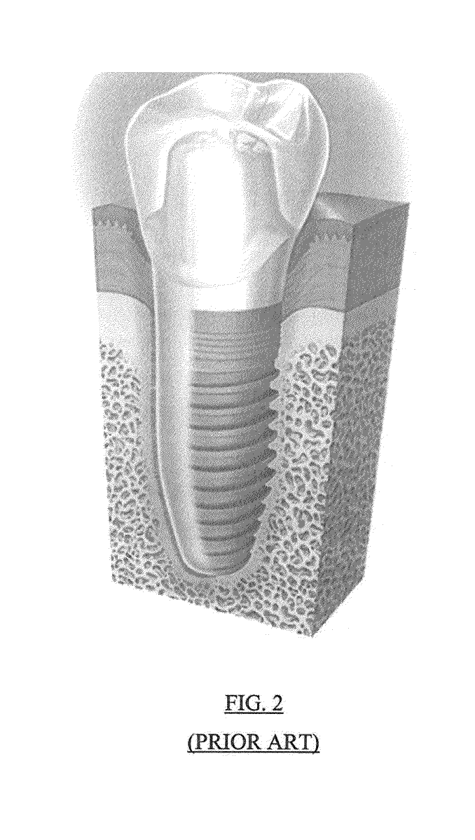

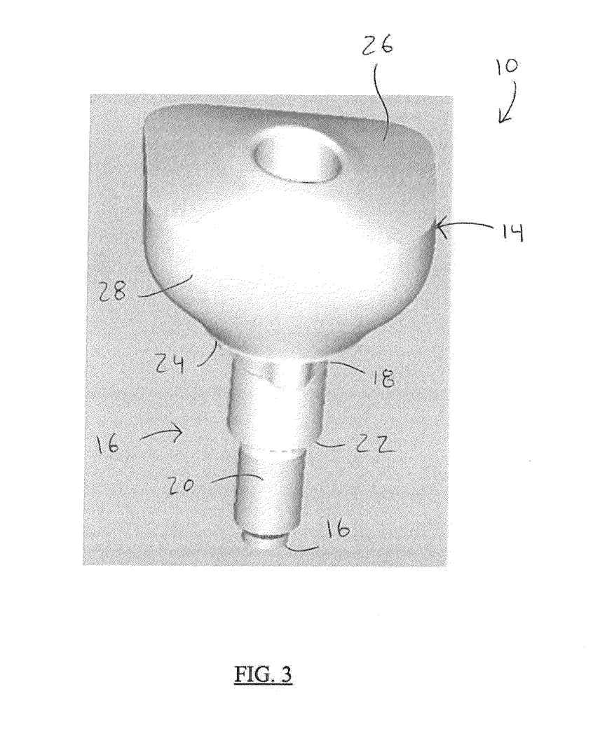

### DETAILED DESCRIPTION OF THE INVENTION

### I. A Custom Healing Abutment

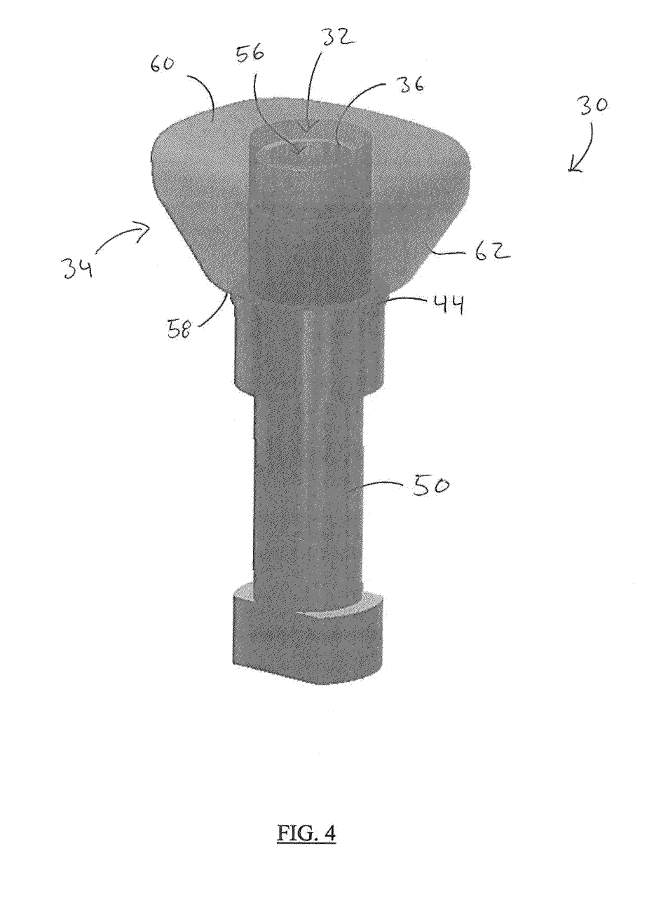

Referring to FIG. 3, in one embodiment the present invention provides a custom healing abutment 10. The custom healing abutment 10 includes a shaft 12 and a head 14. The shaft 12 has a first end 16, a second end 18, and an exterior surface 20 extending between the first and second ends 16, 18. The exterior surface 20 includes one or more outwardly protruding threads 22, between the first and second ends 16, 18. The first end 16 may further define a lower or bottom end of the shaft 12, while the second end may further define an upper or top end of the shaft 12. The head 14 of the custom healing abutment 10 is affixed to the shaft 12 at the second end 18 and extends upwards, away from the first end 16 of the shaft 12. The head 14 of the custom healing abutment 10 includes a first end 24, a second end 26 and a sidewall 28 extending between the first and second ends 24, 26. The first end 24 of the head 14 may define the lower surface of the head 14, while the second end 26 may define the upper surface of the bead 14. The size and shape of the head 14 and specifically the size and shape of the first end 24, second end 26, and sidewall 28 may be independently adjusted in accordance with an embodiment of the present invention as to provide a custom healing abutment 10 having a geometry that is personalized to an individual's anatomical requirements. As will be described in further detail below various user defined variables, i.e., parametric data, may be provided by the user to define the resultant geometry of the custom healing abutment 10, and specifically the head 14. Again, as will be described in further detail below, additional parameters may be derived from the user provided parametric data, and combined therewith, along with various fixed or predetermined parameters to define the geometry of the custom healing abutment 10.

In use, the custom healing abutment 10 is configured to be received within the interior threaded channel of a dental implant, after the implant has been placed into the jaw bone of a patient. The shaft 12 and its outwardly extending threads 22 engage the inner facing threaded surface of the implant's inner chamber, such that the custom healing abutment may be screwed into the placed implant. Additionally, the shaft 12 may include one or more anti-rotational protrusion or contours disposed about its exterior surface 20, and preferably adjacent the second end 18 to inhibit rotation of the custom healing abutment 10. When secured within the implant, the first end 16 of the shaft 12 is located in the inner most portion of the implant's inner channel, while the second end 18 of the shaft 12 is located adjacent the upper must surface of the dental implant, which corresponds approximately to the upper surface of the jaw bone. In this configuration, the first end 24 of the head 14 engaged the upper surface of the dental implant and jaw bone as a means of preventing the gingiva from healing over the implant's upper surface. The opposed second end 26 of the head 24 extends in the opposite direction, and preferably above the upper surface of the gingival tissue. Accordingly, the sidewall 28 engages the gingival tissue and provides an anatomically customized surface upon which the gingival tissue may engage during the healing process. Resultantly, the use of the custom healing abutment 10 results in the formation of an anatomically customized emergence profile that approximates the geometry of the permanent abutment and decreased or eliminates complications otherwise associated with common generic healing abutments.

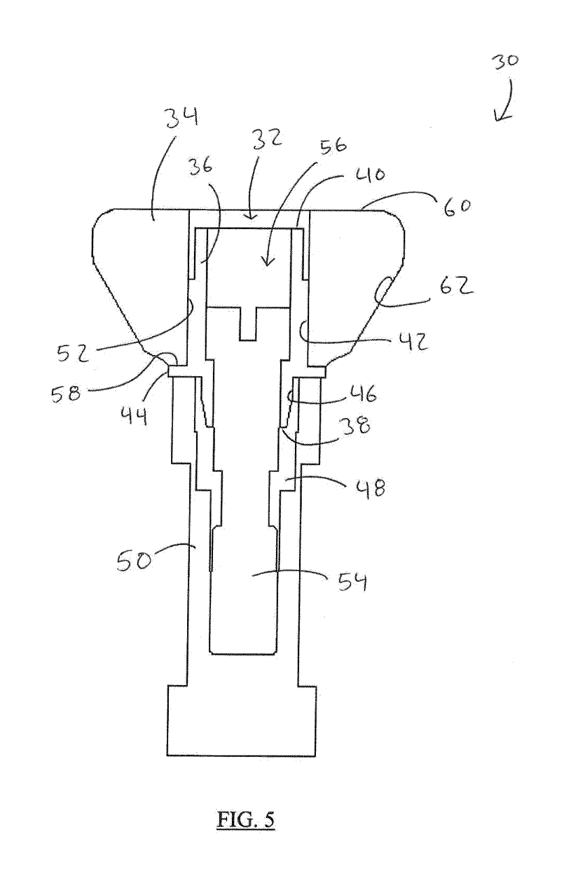

Turning now to FIGS. 4 and 5, an alternative embodiment of the present invention provides a custom healing abutment 30 having a central aperture 32 extending through a head 34. The central aperture 32 is configured to receive therein a removable base 36. The base 36 is preferably funned of a durable and biocompatible metal such as titanium, and by way of example may be a DESS® Interface Ti Base sold by Dess-Abutments of Düsseldorf, Germany. The base 36 includes a first end 38, a second end 40 and an exterior surface 42 extending between the first and second ends 38, 40. The exterior surface 42 may be substantially cylindrical and include an outwardly protruding flange 44 thereon, between the first and second ends 38, 40. As shown in FIG. 5, the first side 46 of the base 36, located between the flange 44 and the first end 38 is configured to be received within the interior cavity 48 of the dental implant 50, while the second side 52 of the base 36, located between the flange 44 and the second end 40 is configured to be received within the central aperture 32 of the custom healing abutment 30. The custom healing abutment 30 may be affixed to the second side 52 of the base 36 by means of adhesive, or any other fixation means commonly known in the art.

As seen in FIGS. 4 and 5, once the custom healing abutment 30 has been affixed the base 36, the base 36 is inserted into cavity 48 of the dental implant 50. When fully seated, the protruding flange 44 of the base 36 will engage the upper surface of the dental implant 50. With the custom healing abutment 30 and base 36 fully seated in the implant 50, a screw 54 is passed through a central cavity 56 in the base 36, and tightened to engage the threaded members of the implant 50, thereby securing the custom healing abutment 30 and base 35 to the implant.

As described above in the prior embodiment, the size and shape of the head 34 and specifically the size and shape of the first end 58, second end 60, and sidewall 62 may be independently adjusted in accordance with an embodiment of the present invention as to provide a custom healing abutment 30 having a geometry that is personalized to an individual's anatomical requirements once secured to an implant 50, as described above.

In one embodiment of this invention, the base 36 may be removed from the custom healing abutment 30 after the surrounding gingival tissue has healed in the desired locations by first removing the screw 54 and then disengaging the adhesive bond between the second side 52 of the base 36 and the central aperture 32 of the head 34. After removal, the base 34 may be reused in the placement of a permanent abutment, such as a ceramic abutment.

### II. Method of Manufacture

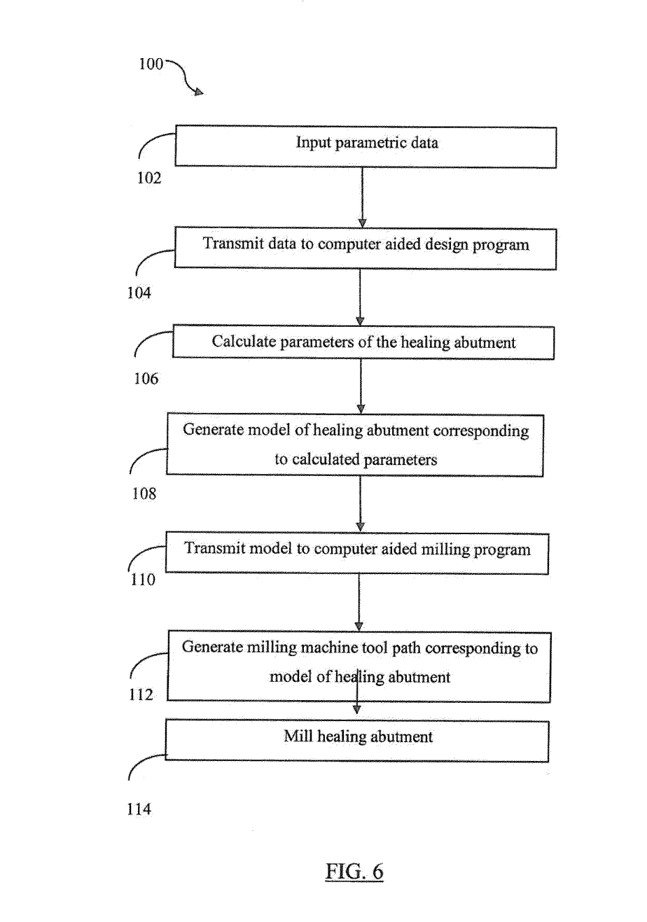

In one embodiment of the current invention a method 100 of manufacturing the custom healing abutment 10, 30 is provided in which the custom healing abutment 10 or head 34 is directly milled from a blank of material, i.e., subtractively fabricated. Turning now to FIG. 6, the method 100 is shown using one or more computer programs, and more specifically to a computer program linked to a network, such as a local area network, web-based, or the internet. However, it is considered well within the scope of this invention that the method 100 or a portion thereof may be practiced without a computer or a network linked computer. The method 100 as shown begins with the user input of parametric data in block 102. The parametric data may include identifying any or all of the following parameters, but is not limited to: the dental implant used during dental surgery, the diameter of the dental implant, the cross sectional shape of the dental implant at the position of the gingival emergence, depth, i.e., emergence, of the prosthetic platform, height of the healing abutment, facial or lingual length of the healing abutment, three dimensional angulation of the implant represented by its angular relationship with either the Frankfort Horizontal Plane or the occlusal plane of the specified arch, described in the form of a unit vector, and mesial or distal dimension of the healing abutment. Data may be entered into the software via any form of human interface device including keyboard text entry, point and click or dropdown menu selection via a mouse or touchpad, or verbal input via headset or microphone.

As regard the angulation of the implant specifically, this parametric data may be represented as a unit vector indicated above. Identifying the unit vector may involve defining the unit vector relative to a base rectilinear coordinate system. Tomography of the individual, such as a cone beam computed tomography (CBCT) image, may be used in establishing this base rectilinear coordinate system and an accepted anatomical horizontal plane therein.

After the parametric data has been entered, the data is transmitted to a computer aided design (CAD) program at block 104. At subsequent block 106, the CAD program calculates the parameters of the custom healing abutment 10, 30 based on a combination of the user input parametric data, calculations derived from the user input received data, and/or fixed data. The calculations of the parameters of the custom healing abutment 10, 30 at block 106 may include a series of mathematical functions that are configured to maintain features of the healing abutment proportionate relative to the parametric data input at block 102. By way of example, one calculation at block 106 may include generating an outer radius at a portion of the healing abutment head 14, 34 that is 1.5 times greater than the size of a linear measurement of a lingual width of a rectangular abutment measured at block 102. However, this exemplary calculation is offered only by way of example of the many calculations that occur at bock 106, as would be known in the art. At block 108, the CAD program then proceeds to generate a model of the custom healing abutment 10 or head 34, corresponding the various parameters at block 106. In one embodiment, the model may be newly generated for each healing abutment request; and in an alternative embodiment, a model corresponding to the user input parametric data may be selected from a preformed library of possible models.

Once generated by the CAD program, the model data is subsequently transmitted to a computer aided milling (CAM) program associated with a milling machine, such as a CNC mill, at block 110. At block 112, the CAM program generates a tool path necessary to form the custom healing abutment 10 or head 34 corresponding to the model that was generated by the CAD program as block 108. The milling machine then proceeds to execute the tool path at block 114, thereby converting the material blank into the custom healing abutment 10 or head 34 corresponding to the user input parametric data. In one embodiment of the present invention the martial blank is a biocompatible nonreactive material such as titanium, surgical grade stainless steel, gold, zirconia, other ceramic materials, polyether ether ketone (PEEK), other thermoplastic polymer, or any combination thereof.

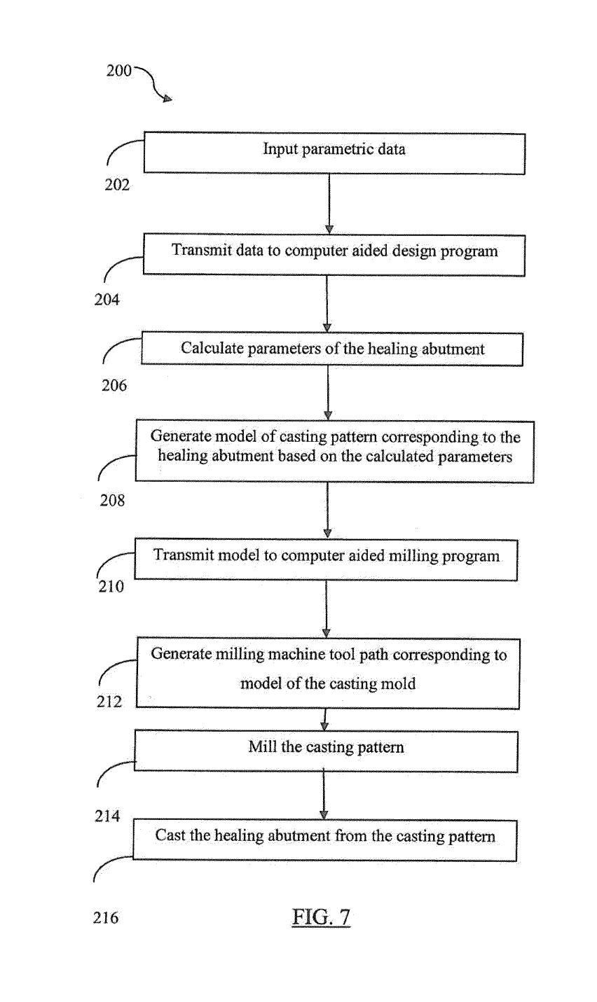

In an alternative embodiment of the current invention a method 200 of manufacturing the custom healing abutment 10, 30 is provided in which a pattern, such as a sacrificial pattern for investment casting the custom healing abutment 10 or head 34 is milled from a blank of material, i.e., subtractively fabricated. Turning now to FIG. 7, the method 200 is shown using one or more computer programs, and more specifically to a computer program linked to a network, such as a local area network, web-based, or the interne. However, it is considered well within the scope of this invention that the method 200 or a portion thereof may be practiced without a computer or a network linked computer. The method 200 as shown begins with the user input of parametric data in block 202. The parametric data may include identifying any or all of the following parameters, but is not limited to: the dental implant used during dental surgery, the diameter of the dental implant, the cross sectional shape of the dental implant at the position of the gingival emergence, depth, i.e., emergence, of the prosthetic platform, height of the healing abutment, facial or lingual length of the healing abutment, angle of the dental implant plan with respect to the occlusal plane, and mesial or distal dimension of the healing abutment. Data may be entered into the software via any form of human interface device including keyboard text entry, point and click or dropdown menu selection via a mouse or touchpad, or verbal input via headset or microphone.

After the parametric data has been entered, the data is transmitted to a computer aided design (CAD) program at block 204. At subsequent block 206, the CAD program calculates the parameters of the custom healing abutment 10 based on a combination of the user input parametric data, calculations derived from the user input received data, and/or fixed data. Then at block 208, the CAD program then proceeds to generate a model of a casting pattern corresponding to the desired custom healing abutment 10 or head 34, based on the data input at block 206. In one embodiment, the model of the casting pattern may be newly generated for each healing abutment request; and in an alternative embodiment, a model corresponding to the user input parametric data may be selected from a preformed library of possible models.

Once generated by the CAD program, the model data is subsequently transmitted to a computer aided milling (CAM) program associated with a milling machine, such as a CNC mill, at block 210. At block 212, the CAM program generates a tool path necessary to form the casting pattern for a custom healing abutment corresponding to the model that was generated by the CAD program as block 208. The milling machine then proceeds to execute the tool path at block 214, thereby converting the material blank into the casting pattern corresponding to the user input parametric data. In one embodiment, the material blank is formed of wax, acrylic, foam or similar sacrificial material configured to form an investment casting pattern. Once the casting pattern has been milled, it is removed from the milling machine and the custom healing abutment 10 or head 34 is formed in accordance with conventional casting techniques at block 216, namely by building a casting shell around the pattern, removing the casting pattern from the shell, filling the resultant hollow cavity with a molten material such as but not limited to gold or cobalt, and removing the outer casting shell once the resultant healing abutment 10 or head 34 has solidified.

In another embodiment, the casting pattern generated in accordance with the above method may be limited to the head 14, 34 of the custom healing abutment 10, 30 respectively. In such an embodiment the threaded shaft 12 of the custom healing abutment 10 or base 36 of the custom healing abutment 30 may be prefabricated, and may be formed of a chrome-cobalt alloy or similarly nonreactive biocompatible material. During casting this preformed threaded shaft 12 or base 36, which is configured to be received within the central channel of the dental implant, may be positioned adjacent the casting pattern such that the head 14, 34 portion of the custom healing abutment 10, 30 is cast onto and integrated with the preformed threaded shaft 12 or base 36. Alternatively, the head 14, 34 portion of the custom healing abutment 10, 30 may be independently manufactured and secured or affixed to and integrated with the preformed threaded shaft 12 or base 36 by way of cement or other fixation means.

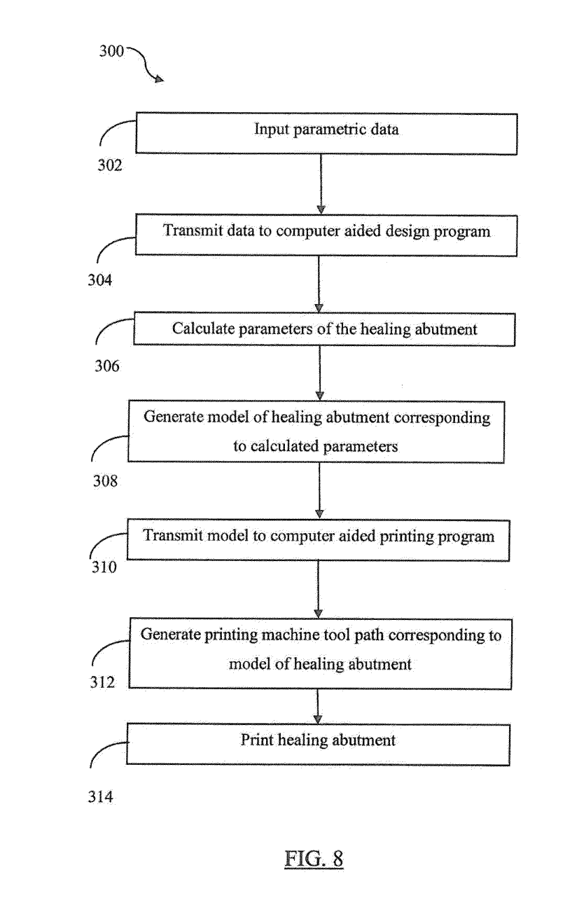

In yet another embodiment of the current invention a method 300 of manufacturing the custom healing abutment 10, 30 is provided in which the custom healing abutment 10 or head 34 is three dimensionally printed, i.e., additively fabricated. Turning now to FIG. 8, the method 300 is shown using one or more computer programs, and more specifically to a computer program linked to a network, such as a local area network, web-based, or the internet. However, it is considered well within the scope of this invention that the method 300 or a portion thereof may be practiced without a computer or a network linked computer. As with the previously discussed methods, at block 302, the current method 300 begins with the user input of parametric data that may include but is not limited to: the dental implant used during dental surgery, the diameter of the dental implant, the cross sectional shape of the dental implant at the position of the gingival emergence, depth, i.e., emergence, of the prosthetic platform, height of the healing abutment, facial or lingual length of the healing abutment, angle of the dental implant plan with respect to the occlusal plane, and mesial or distal dimension of the healing abutment. This data may be entered into the software via any form of human interface device including keyboard text entry, point and click or dropdown menu selection via a mouse or touchpad, or verbal input via headset or microphone.

After the parametric data has been entered, the data is again transmitted to a computer aided design (CAD) program at block 304. The CAD program may be located on the same computer as the program used for user input of the parametric data, or it may be located on a discrete and/or remotely located computer. At subsequent block 306, the CAD program calculates the parameters of the custom healing abutment 10 based on a combination of the user input parametric data, calculations derived from the user input received data, and/or fixed data. Then at block 308, the CAD program proceeds to generate a model of a custom healing abutment 10 or head 34, corresponding the various parameters at block 306. In one embodiment, the model may be newly generated for each healing abutment request; and in an alternative embodiment, a model corresponding to the user input parametric data may be selected from a preformed library of possible models.

Once generated by the CAD program, the model data is subsequently transmitted to a computer aided printing program associated with a three dimensional printing machine, at block 310. Again, the computer aided printing program may be located on either the same or a discrete computer as to the CAD program and the program used for user input of the parametric data. At block 312, the computer aided printing program generates a printing tool path necessary to form the custom healing abutment 10 or head 34 corresponding to the model that was generated by the CAD program as block 308. The three dimensional printer then proceeds to execute the printing tool path at block 314, thereby extruding a molten substrate material in the form of the custom healing abutment 10 or head 34 corresponding to the user input parametric data. In some embodiments, the substrate material may be a biocompatible material configured for use with a three dimensional printer or other additive fabrication device, including but not limited to SLA and MP printing devises, such as polyether ether ketone (PEEK), poly(methyl methacrylate), or similar biocompatible thermoplastic, for example E-Dent manufactured by Envisions Tec of Gladbeck, Germany. In other embodiments, the substrate material may be or include a powder additive that is subsequently sintered prior to forming the final custom healing abutment 10 or head 34.

In another embodiment, the custom healing abutment 10, 30 generated in accordance with the above method may be limited to the head 14, 34 portion of the custom healing abutment 10, 30 respectively. In such an embodiment the threaded shaft 12 or base 36 of the custom healing abutment 10, 30 may be prefabricated, and may be formed of a chrome-cobalt alloy or similarly nonreactive biocompatible material. During printing this preformed threaded shaft 12 or base 36, which is configured to be received within the central channel of the dental implant, may be positioned such that the head 14, 34 portion of the custom healing abutment 10, 30 is printed onto and integrated with the preformed threaded shaft 12 or base 36. Alternatively, the head 14, 34 portion of the custom healing abutment 10, 30 may be secured or affixed to and integrated with the preformed threaded shaft 12 or base 36 by way of cement or other fixation means.

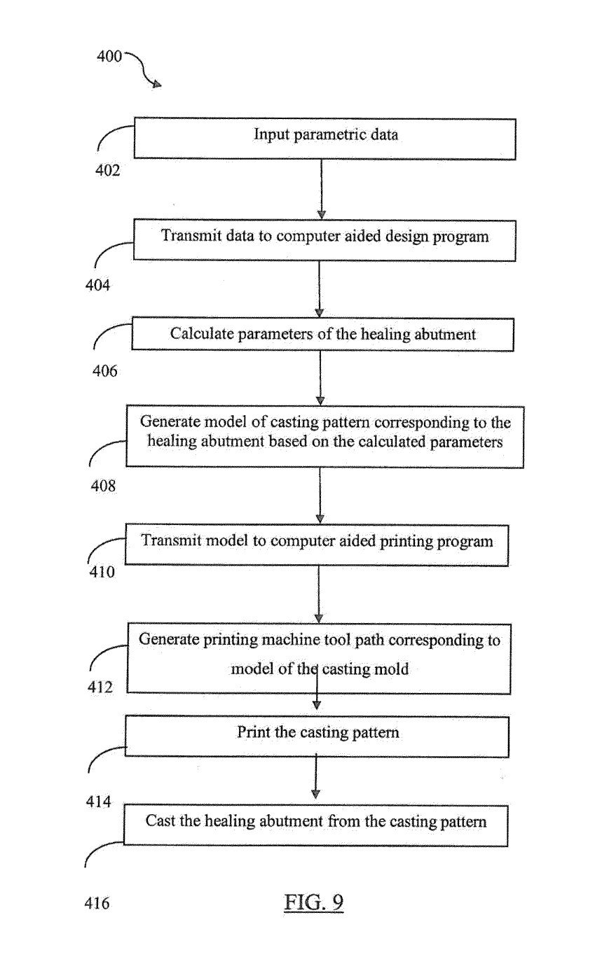

In yet another embodiment of the current invention a method 400 of manufacturing the custom healing abutment 10, 30 is provided in which the pattern, such as a sacrificial pattern for investment casting the healing abutment is three dimensionally printed, i.e., additively fabricated. Turning now to FIG. 9, the method 400 is shown using one or more computer programs, and more specifically to a computer program linked to a network, such as a local area network, web-based, or the internet. However, it is considered well within the scope of this invention that the method 400 or a portion thereof may be practiced without a computer or a network linked computer. Again, as with the above methods, at block 402, the current method 400 begins with the user input of parametric data that may include but is not limited to: the dental implant used during dental surgery, the diameter of the dental implant, the cross sectional shape of the dental implant at the position of the gingival emergence, depth, emergence, of the prosthetic platform, height of the healing abutment, facial or lingual length of the healing abutment, angle of the dental implant plan with respect to the occlusal plane, and mesial or distal dimension of the healing abutment. This data may be entered into the software via any form of human interface device including keyboard text entry, point and click or dropdown menu selection via a mouse or touchpad, or verbal input via headset or microphone.

After the parametric data has been entered, the data is again transmitted to a computer aided design (CAD) program at block 404. The CAD program may be located on the same computer as the program used for user input of the parametric data, or it may be located on a discrete and/or remotely located computer. At subsequent block 406, the CAD program calculates the parameters of the healing abutment based on a combination of the user input parametric data, calculations derived from the user input received data, and/or fixed data. Then at block 408, the CAD program then proceeds to generate a model of a casting pattern corresponding to the desired custom healing abutment 10 or head 34, based on the various parameters generated at block 406. In one embodiment, the model of the casting pattern may be newly generated for each healing abutment request; and in an alternative embodiment, the model of the casting pattern corresponding to the user input parametric data may be selected from a preformed library of possible models.

Once generated by the CAD program, the model data is subsequently transmitted to a computer aided printing program associated with a three dimensional printing machine, at block 410. Again, the computer aided printing program may be located on either the same or a discrete computer as to the CAD program and the program used for user input of the parametric data. At block 412, the computer aided printing program generates a printing tool path necessary to form the casting pattern used to form a custom healing abutment 10 or head 34 corresponding to the model that was generated by the CAD program as block 408. The three dimensional printer then proceeds to execute the printing tool path at block 414, thereby extruding a molten substrate material in the form of the casting pattern for forming a custom healing abutment 10 or head 34 corresponding to the user input parametric data. In one embodiment, the material blank is formed of wax, acrylic, foam or similar material configured to form an investment casting pattern. Once the casting pattern has been printed or additively formed, it is removed from the three dimensional printer and the healing abutment 10 or head 34 is formed in accordance with conventional casting techniques at block 416, namely by building a casting shell around the pattern, removing the casting pattern from the shell, filling the resultant hollow cavity with a molten material such as but not limited to gold or cobalt, and removing the outer casting shell once the resultant healing abutment 10 or head 34 has solidified.

In another embodiment, the casting pattern generated in accordance with the above method may be limited to the head 14, 34 portion of the custom healing abutment 10, 30. In such an embodiment the threaded shaft 12 or base 36 of the custom healing abutment 10, 30 may be prefabricated, and may be formed of a chrome-cobalt alloy or similarly nonreactive biocompatible material. During casting this preformed threaded shaft 12 or base 36, which is configured to be received within the central channel of the dental implant, may be positioned adjacent the printed casting pattern such that the head 14, 34 portion of the custom healing abutment 10, 30 is cast onto and integrated with the preformed threaded shaft 12 or base 36. Alternatively, the head 14, 34 portion of the custom healing abutment 10, 30 may be cast independently and secured or affixed to and integrated with the preformed threaded shaft 12 or base 36 by way of cement or other fixation means.

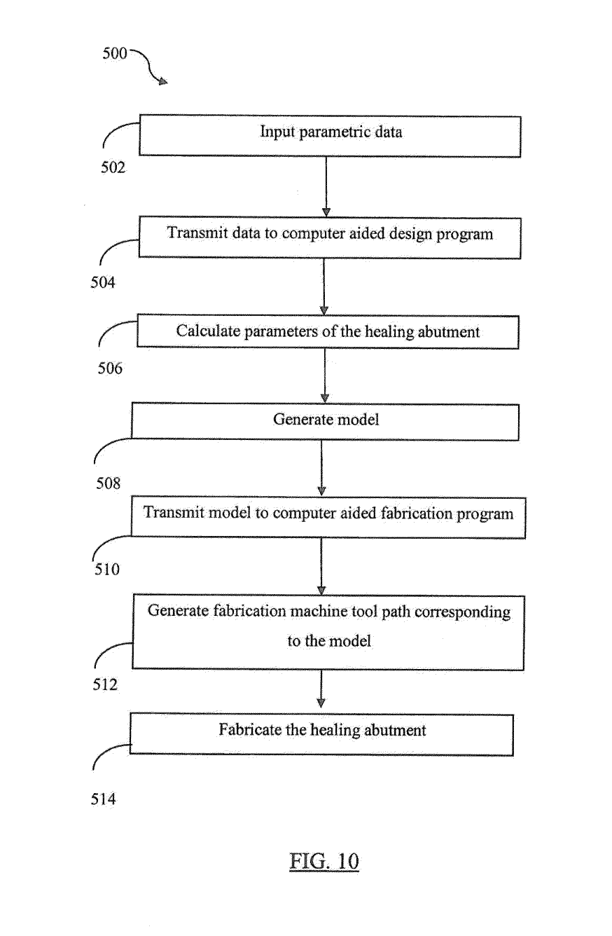

In yet another embodiment of the current invention, a method 500 of manufacturing the custom healing abutment 10, 30 is provided, as shown in FIG. 10. As with the above methods, at block 502, the current method 500 begins with the user input of parametric data that may include but is not limited to: the dental implant used during dental surgery, the diameter of the dental implant, the cross sectional shape of the dental implant at the position of the gingival emergence, depth, i.e., emergence, of the prosthetic platform, height of the healing abutment, facial or lingual length of the healing abutment, angle of the dental implant plan with respect to the occlusal plane, and mesial or distal dimension of the healing abutment. After the parametric data has been entered, the data is transmitted to a computer aided design (CAD) program at block 504. At subsequent block 506, the CAD program calculates the parameters of the healing abutment based on a combination of the user input parametric data, calculations derived from the user input received data, and/or fixed data. Then at block 508, the CAD program proceeds to generate a model of a custom healing abutment 10 or head 34. Once generated by the CAD program, the model data is subsequently transmitted to a computer aided fabricating program associated with a fabrication machine, at block 510. At block 512, the computer aided fabrication program generates a fabrication machine tool path necessary to fabricate a custom healing abutment 10 or head 34 corresponding to the model that was generated by the CAD program as block 508. The fabrication machine then proceeds to execute the fabrication tool path at block 514, thereby fabricating the custom healing abutment 10 or head 34. In this embodiment, the fabrication machine may either be a milling machine or printing machine capable of additive or subtractive fabrication respectively.

In the various methods described above, the user may generate the user input parametric data for entry in blocks 102, 202, 302, 402, and 502 in various means. In one embodiment of the current invention, the user may manually form a plaster model and/or mock up of the dental implant surgical cite, prior to surgery, by taking an impression of the patient's mouth. From this plaster model the user may take measurements, which are then input into the present invention's method of manufacture 100, 200, 300, 400, 500 as user input parametric data from which the custom healing abutment 10, 30 is formed.

In another embodiment, the user input parametric data may be extracted from an imaging scan of the patient. For example, a cone beam computed tomography (CBCT) image may be generated of the patient's mouth prior to dental implant surgery. If the tooth or teeth that are to be replaced via surgery are present, measurements including soft tissue emergence, length, width and height may be taken directly from the image of these corresponding teeth. However, in the more common scenario where the teeth to be replaced with implant and restorative prosthetic are missing, the contralateral, i.e., opposite side, tooth may be mathematically flipped and then used as a means for providing measurements for the desired tooth's custom healing abutment according to the present invention. These measurements may either be manually acquired from the image file, or their acquisition may be automated. The resultant measurements are then input into the present invention's method of manufacture 100, 200, 300, 400 as user input parametric data in blocks 102, 202, 302, 402, 502. Of course, the use of imaging scan data is in no way limited to CBCT images, and may include any other form of medical imaging known in the art including but not limited to MRI, CT, X-ray, etc.

Certain embodiments according to the invention have been disclosed. These embodiments are illustrative of, and not limiting on, the invention. Other embodiments, as well as various modifications and combinations of the disclosed embodiments, are possible and are within the scope of this disclosure. Various other embodiments of the present invention are contemplated as being within the scope of the filed claims particularly pointing out and distinctly claiming the subject matter regarded as the invention.

1. A custom healing abutment device comprising:
a head received at an end of a dental implant and configured to engage the surrounding gingival tissue, the head having a first end, a second end, and a sidewall extending from the first end to the second end,
the head further having a geometry defined by the first end, second end and sidewall that is customized to the anatomy of an individual receiving the custom healing abutment.

2. The custom healing abutment device of claim 1, also having a shaft extending from the first end of the head, configured to engage an inner channel of the dental implant.

3. The custom healing abutment device of claim 1, wherein the head includes a central aperture configured to receive a removable base therein.

4. The custom healing abutment device of claim 1, wherein the head is three dimensionally printed from a biocompatible acrylic and has a central aperture configured to received a removable base therein.

5. A method of manufacturing a custom healing abutment, comprising the steps of:
receiving data defining one or more initial parameters of a geometry of a custom healing abutment;
using the data to generating subsequent parameters of the geometry of the custom healing abutment;
generating a model of the custom healing abutment from the initial and subsequent parameters;
defining a tool pathway for forming the custom healing abutment according to the model;
activating a tool to form the custom healing abutment according to the tool pathway.

6. The method of claim 5, wherein the one or more initial parameters of a geometry of a custom healing abutment are selected from a group including: a type of dental implant, a cross sectional diameter of the dental implant, a cross sectional shape of the dental implant at a position of the gingival emergence, a depth of a prosthetic platform, a height of the healing abutment, a facial length of the healing abutment a lingual length of the healing abutment an angle of the dental implant plan with respect to an occlusal plane, a mesial dimension of the healing abutment, and a distal of the healing abutment.

7. The method of claim 5, wherein the step of receiving data defining one or more initial parameters of the geometry of the custom healing abutment includes the step of:
extracted data defining one or more initial parameters of the geometry of the custom healing abutment from an imaging scan of a patient.

8. The method of claim 7, wherein the image scan is selected from a group including: a cone beam computed tomography image, a MRI image, a CT image, and a X-ray image.

9. The method of claim 5, wherein the step of receiving data defining one or more initial parameters of the geometry of the custom healing abutment includes the steps of:
measuring a corresponding contralateral tooth to provide initial measurements corresponding to the one or more initial parameters of the geometry of the custom healing abutment, and
inverting the values of the initial measurements to compensate for the contralateral tooth position and provide the one or more initial parameters of the geometry of the custom healing abutment.

10. The method of claim 5, wherein the step of using the data to generating subsequent parameters of the geometry of the custom healing abutment includes the step of;
calculating one or more subsequent parameters of the custom healing abutment based the user input parametric data.

11. The method of claim 10, wherein the step of using the data to generating subsequent parameters of the geometry of the custom healing abutment also includes the step of:
providing one or more subsequent parameters of the custom healing abutment from fixed data.

12. The method of claim 5, wherein the step of generating the model of the custom healing abutment from the initial and subsequent parameters included the step of:
generating a computer model of the custom healing abutment from a combination of the data, one or more subsequent parameters of the healing abutment derived from the data, and fixed data.

13. The method of claim 5, wherein the model of the custom healing abutment is a model of a head of the custom healing abutment.

14. The method of claim 13, wherein the head of the custom healing abutment included a central aperture configured to receive a removable base therein.

15. The method of claim 5, wherein the tool is an additive fabrication tool.

16. The method of claim 15, wherein the additive fabrication tool is a three dimensional printer configured to form the custom healing abutment from a biocompatible acrylic.

17. The method of claim 15, wherein the step of activating the tool to form the custom healing abutment according to the tool pathway includes the step of:
three dimensionally printing a head of the custom healing abutment having a central aperture configured to received a removable base therein from a biocompatible acrylic.

18. The method of claim 5, wherein the tool is a subtractive fabrication tool.

19. The method of claim 18, wherein the step of activating the tool to form the custom healing abutment according to the tool pathway includes the step of:
milling a head of the custom healing abutment having a central aperture configured to received a removable base therein from a blank of biocompatible acrylic.

20. A method of manufacturing a custom healing abutment, comprising the steps of:
receiving data defining one or more initial parameters of a geometry of a custom healing abutment selected from a group including: a type of dental implant, a cross sectional diameter of the dental implant, a cross sectional shape of the dental implant at a position of the gingival emergence, a depth of a prosthetic platform, a height of the healing abutment, a facial length of the healing abutment, a lingual length of the healing abutment, an angle of the dental implant plan with respect to an occlusal plane, a mesial dimension of the healing abutment, and a distal of the healing abutment;
calculating one or more subsequent parameters of the custom healing abutment based the user input parametric data;
providing fixed data defining one or more subsequent parameters of the custom healing abutment;
generating a computer model of the custom healing abutment from a combination of the initial parameters, the one or more subsequent parameters, and the fixed data;
defining a tool pathway for forming the custom healing abutment according to the model;
activating a tool to form the portion of the custom healing abutment according to the tool pathway.
